(19) United States
(12) Patent Application Publication
(10) Pub. No.: US 2017/0120092 A1
(43) Pub. Date: May 4, 2017

(54) Compressed Air Foam Fluid Mixing Device

(71) Applicant: WATEROUS Company, South St. Paul, MN (US)

(72) Inventors: Mark Francis Haider, St. Paul, MN (US); Gregg Allen Geske, Chanhassen, MN (US)

(73) Assignee: WATEROUS Company, South St. Paul, MN (US)

(21) Appl. No.: 15/296,359

(22) Filed: Oct. 18, 2016

Related U.S. Application Data
(60) Provisional application No. 62/250,204, filed on Nov. 3, 2015.

(51) Int. Cl. A62C 5/02

(52) U.S. Cl. CPC A62C 5/022

(57) ABSTRACT

The present invention is a mixing device for producing compressed foam for an extinguishing device for firefighting comprising a foam solution inlet that is operatively connected to a foam solution mixture area that is operatively connected to a compressed air inlet that is operatively connected to a compressed air injection manifold that is operatively connected to a mixing chamber. The compressed air injection manifold having a plurality of lateral sides that have a plurality of holes distributed across at least one of the lateral sides. A scrubbing collector pipe that extends into the mixing chamber to form an annular flow area within the mixing chamber. The scrubbing collector pipe having a plurality of holes distributed around an outer periphery of the scrubbing collector pipe. An inner collector pipe within the scrubbing collector pipe. A compressed air foam outlet operatively connected to the scrubbing collector pipe.

### CROSS REFERENCES TO RELATED APPLICATIONS

This application claims priority from and is related to commonly owned U.S. Provisional Patent Application Ser. No. 62/250,204 filed Nov. 3, 2015, entitled: COMPRESSED AIR FOAM FLUID MIXING DEVICE, this Provisional Patent Application incorporated by reference herein.

### FIELD OF THE INVENTION

This invention relates generally to mixers for use in a system for supplying compressed air and foam to produce a fire stream comprising an aerated foam.

### BACKGROUND OF THE INVENTION

Compressed air foam (CAF) is used to extinguish fires and is generally comprised of a combination of water and a foam concentrate mixed together to form a foam solution. Compressed air foam is then added to the foam solution so as to deliver compressed air foam (CAF) for delivery to a fire. The quality and consistency of the CAF is dependent on the thoroughness of the mixing of the air and foam solution and the structure of the CAF bubble formed within the mixing device before delivery to the fire through a fire hose or monitor nozzle. Current methods and devices for mixing the compressed air and foam solution often supply the compressed air into a single injection port in the outer periphery of a plumbing component such as a valve body, fitting or pipe through which the foam solution is flowing. With such single point injection, the compressed air is not evenly distributed within the foam solution and the resulting CAF bubble structure is inconsistent. Static mixers or scrubbers that consist of a series of plates, perforated plates or discs or other irregular shapes are commonly placed downstream of the air injection location to disrupt the flow path and to cause turbulence to further mix the compressed air and foam solution. While this disruption of flow improves mixing and the formation of the CAF foam, friction loss through the device increases which reduces the pressure of the CAF stream delivered and limits the reach from a fire hose or nozzle onto a fire. Also, when the discharge is used for water only and is not used for CAF, the increased friction loss will limit the flow rate and reach from a fire hose or nozzle.

Therefore, it is an object of the present invention to provide an improvement which overcomes the inadequacies of the prior art methods and devices and which is a significant contribution to the advancement of the compressed air foam art.

Another object of the present invention is to provide a mixing device for producing compressed foam for an extinguishing device for firefighting comprising a foam solution inlet; a foam solution mixture area operatively connected to said foam solution inlet; a compressed air inlet operatively connected to said foam solution mixture area; a compressed air injection manifold operatively connected to said compressed air inlet, said compressed air injection manifold having a plurality of lateral sides having a plurality of holes distributed across at least one of said lateral sides; a mixing chamber operatively connected to said compressed air injection manifold; a scrubbing collector pipe that extends into said mixing chamber to form an annular flow area within the mixing chamber, said scrubbing collector pipe having a plurality of holes distributed around an outer periphery of said scrubbing collector pipe; an inner collector pipe within said scrubbing collector pipe; and a compressed air foam outlet operatively connected to said scrubbing collector pipe.

Yet another object of the present invention is to provide mixing device for producing compressed foam for an extinguishing device for firefighting comprising a foam solution inlet; a foam solution mixture area operatively connected to said foam solution inlet; a compressed air inlet operatively connected to said foam solution mixture area; a mixing chamber operatively connected to said compressed air inlet; a scrubbing collector pipe that extends into said mixing chamber to form an annular flow area within the mixing chamber; and a compressed air foam outlet operatively connected to said scrubbing collector pipe.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

A feature of the present invention is to provide a mixing device for producing compressed foam for an extinguishing device for firefighting comprising a foam solution inlet that is operatively connected to a foam solution mixture area that is operatively connected to a compressed air inlet that is operatively connected to a compressed air injection manifold that is operatively connected to a mixing chamber. The compressed air injection manifold having a plurality of lateral sides that have a plurality of holes distributed across at least one of the lateral sides. A scrubbing collector pipe that extends into the mixing chamber to form an annular flow area within the mixing chamber. The scrubbing collector pipe having a plurality of holes distributed around an outer periphery of the scrubbing collector pipe. An inner collector pipe within the scrubbing collector pipe. A compressed air foam outlet operatively connected to the scrubbing collector pipe. The scrubbing collector pipe can further comprise an annulus. The foam solution inlet can further comprise a flanged inlet connection. The compressed air foam outlet can further comprise a grooved end and an internally threaded outlet connection. The mixing device can further comprise a bottom drain port. The mixing device can further comprise a pressure tap port. The compressed air injection manifold can further comprise a connection port. The mixing device can further comprise a mounting bracket.

Another feature of the present invention is to provide a mixing device for producing compressed foam for an extinguishing device for firefighting comprising a foam solution inlet that is operatively connected to a foam solution mixture area that is operatively connected to a compressed air inlet that is operatively connected to a mixing chamber. The compressed air inlet can further comprise a compressed air injection manifold that can have a plurality of lateral sides that can have a plurality of holes distributed across at least one of the lateral sides. A scrubbing collector pipe that extends into the mixing chamber to form an annular flow area within the mixing chamber. The scrubbing collector pipe can further comprise a plurality of holes distributed around an outer periphery of the scrubbing collector pipe. A compressed air foam outlet operatively connected to the scrubbing collector pipe. The scrubbing collector pipe can further comprise an inner collector pipe within the scrubbing collector pipe. The scrubbing collector pipe can further comprise an annulus. The foam solution inlet can further comprise a flanged inlet connection. The compressed air foam outlet can further comprise a grooved end and an internally threaded outlet connection. The mixing device can further comprise a bottom drain port. The mixing device can further comprise a pressure tap port. The compressed air injection manifold can further comprise a connection port. The mixing device can further comprise a mounting bracket.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a perspective view of one embodiment of the present invention;

FIG. 2 is a schematic view of one embodiment of the present invention;

FIG. 2A is a cross sectional view of FIG. 2 taken along line A-A; and

FIG. 2B is a cross sectional view of FIG. 2 taken along line B-B. Similar reference characters refer to similar parts throughout the several views of the drawings.

### DETAILED DESCRIPTION OF THE INVENTION

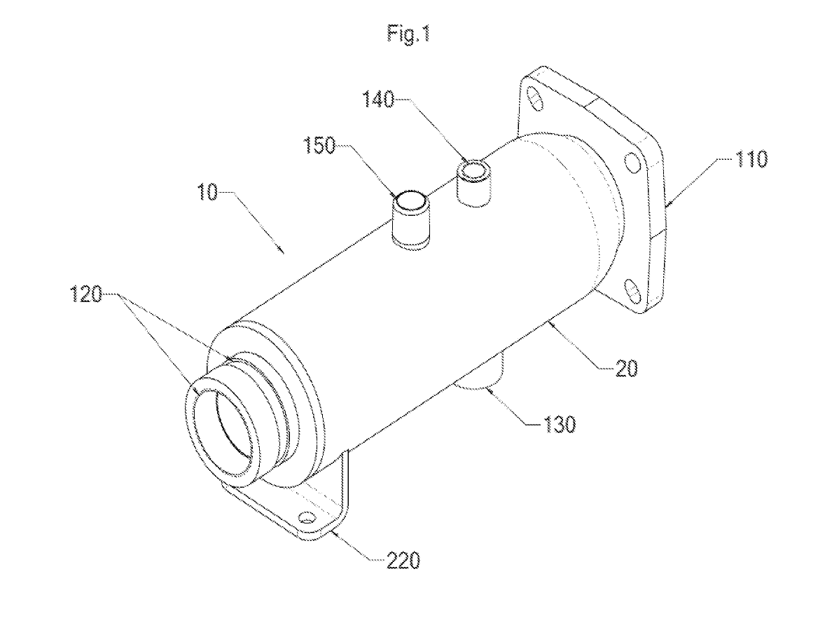

The present invention is a mixing device that improves the mixing of compressed air within the foam solution to improve the CAF bubble structure while reducing the friction loss through the mixing device. FIG. 1 is a perspective view showing one embodiment of the mixing device 10 of the present invention. The housing 20 of the mixing device 10 is shown with a flanged inlet connection 110; a grooved end and internally threaded outlet connection 120; a bottom drain port 130; a pressure tap port 140; and a connection port for compressed air injection manifold 150. Also shown in FIG. 1 is a mounting bracket 220.

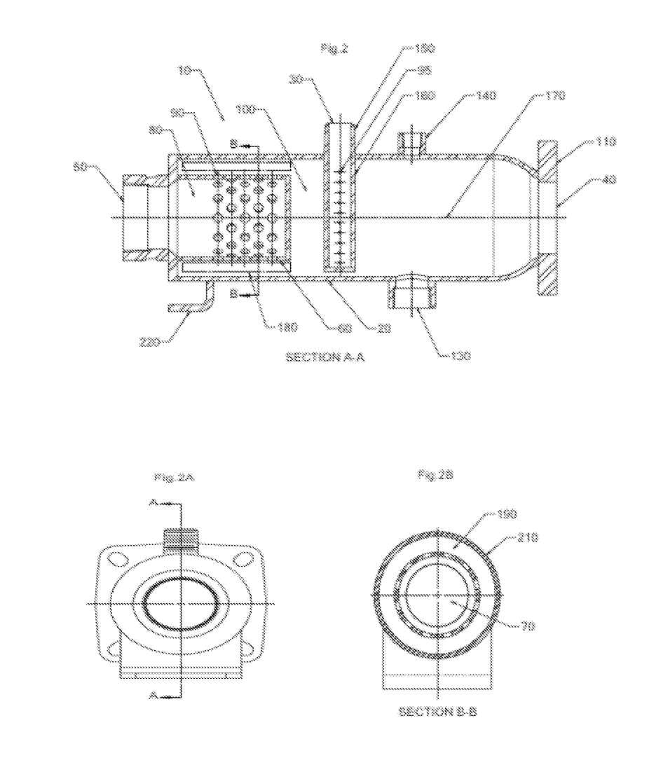

FIG. 2 is a schematic view of one embodiment of the mixing device 10 of the present invention for producing compressed foam for an extinguishing device for firefighting. The housing 20 of the mixing device 10 is shown with the following details. A foam solution flows into the mixing device 10 through a foam solution inlet 40 into a foam solution mixture area 170. The foam solution inlet 40 can further comprise a flanged inlet connection 110. A hose for providing compressed air is connected to a compressed air inlet 30 that is connected to a compressed air injection manifold 160. Compressed air is injected into the mixing device 10 through the compressed air injection manifold 160 that bisects the mixing chamber 100 cross section. The compressed air injection manifold 160 can have a plurality of lateral sides that can have a plurality of holes 95 distributed across at least one of the lateral sides. This distributes compressed air evenly throughout the foam solution flow cross section. The foam solution mixture then flows into an outer annulus 190 between an outer shell 210 of the mixing device and a scrubbing collector pipe 60. The foam solution mixture enters the scrubbing collector pipe 60 through a series of holes 90 distributed around the outer periphery of the scrubbing collector pipe 60. The scrubbing collector pipe 60 extends into the mixing chamber 100 to form an annular flow area 180 within the mixing chamber 100. The placement of the holes 90 around the outer periphery of the scrubbing collector pipe 60 is arranged to distribute the flow pattern evenly into an interior 80 scrubbing collector pipe 60. Specifically, the hole 90 placement stops prior to the left end of the annulus 190 as viewed in FIG. 2. The holes 90 are sized to further enhance the mixing of the air and foam solution and resulting CAF bubble structure while limiting the friction loss as the CAF exits the mixing device 10 through a compressed air foam outlet 50. The compressed air foam outlet 50 can further comprise a grooved end and an internally threaded outlet connection 120. As shown in FIG. 2B, the scrubbing collector pipe can further comprise an inner collector pipe 70 within the scrubbing collector pipe 60.

Other embodiments include configuring the device with different end connections and with different configurations for the air injection manifold and collector pipe. The shape and/or size of the hole in the air injection manifold could vary so that the air injected would vary to match the velocity profile of the solution flow recognizing that the flow velocity is greater in the center of the cross section and less at the outer regions. Therefore, shape and/or size of the hole could be larger at the center and smaller at the ends. For the collector pipe, as the solution mixture passes axially through the annulus region, the shape and/or size of the hole could vary to result in an equal flow rate through each hole. While these embodiments may improve the mixing and friction loss performance of the device, it is recognized that they are more difficult to manufacture.

Essentially, the main benefit of this design is to provide improved mixing of the compressed air and foam solution that produces better compressed air foam with less friction loss that enables improved delivery of the compressed air foam to the fire.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A mixing device for producing compressed foam for an extinguishing device for firefighting comprising:
a foam solution inlet;
a foam solution mixture area operatively connected to said foam solution inlet;
a compressed air inlet operatively connected to said foam solution mixture area;
a compressed air injection manifold operatively connected to said compressed air inlet, said compressed air injection manifold having a plurality of lateral sides having a plurality of holes distributed across at least one of said lateral sides;
a mixing chamber operatively connected to said compressed air injection manifold;
a scrubbing collector pipe that extends into said mixing chamber to form an annular flow area within the mixing chamber, said scrubbing collector pipe having a plurality of holes distributed around an outer periphery of said scrubbing collector pipe;
an inner collector pipe within said scrubbing collector pipe; and
a compressed air foam outlet operatively connected to said scrubbing collector pipe.

2. The mixing device according to claim 1 wherein said scrubbing collector pipe further comprising an annulus.

3. The mixing device according to claim 1 wherein said foam solution inlet further comprising a flanged inlet connection.

4. The mixing device according to claim 1 wherein said compressed air foam outlet further comprising a grooved end and an internally threaded outlet connection.

5. The mixing device according to claim 1 further comprising a bottom drain port.

6. The mixing device according to claim 1 further comprising a pressure tap port.

7. The mixing device according to claim 1 wherein said compressed air injection manifold further comprising a connection port.

8. The mixing device according to claim 1 further comprising a mounting bracket.

9. A mixing device for producing compressed foam for an extinguishing device for firefighting comprising:
a foam solution inlet;
a foam solution mixture area operatively connected to said foam solution inlet;
a compressed air inlet operatively connected to said foam solution mixture area;
a mixing chamber operatively connected to said compressed air inlet;
a scrubbing collector pipe that extends into said mixing chamber to form an annular flow area within the mixing chamber; and
a compressed air foam outlet operatively connected to said scrubbing collector pipe.

10. The mixing device according to claim 9 further comprising a compressed air injection manifold operatively connected to said compressed air inlet.

11. The mixing device according to claim 10 wherein, said compressed air injection manifold further comprising a plurality of lateral sides having a plurality of holes distributed across at least one of said lateral sides.

12. The mixing device according to claim 9 wherein said scrubbing collector pipe further comprising a plurality of holes distributed around an outer periphery of said scrubbing collector pipe.

13. The mixing device according to claim 9 further comprising an inner collector pipe within said scrubbing collector pipe.

14. The mixing device according to claim 9 wherein said scrubbing collector pipe further comprising an annulus.

15. The mixing device according to claim 9 wherein said foam solution inlet further comprising a flanged inlet connection.

16. The mixing device according to claim 9 wherein said compressed air foam outlet further comprising a grooved end and an internally threaded outlet connection.

17. The mixing device according to claim 9 further comprising a bottom drain port.

18. The mixing device according to claim 9 further comprising a pressure tap port.

19. The mixing device according to claim 9 wherein said compressed air injection manifold further comprising a connection port.

20. The mixing device according to claim 9 further comprising a mounting bracket.
